(19) United States
(12) Patent Application Publication
(10) Pub. No.: US 2024/0065169 A1
(43) Pub. Date: Feb. 29, 2024

(54) Field Grain Cart with Expandable Sides

(71) Applicant: Jon M. Polries, Sykeston, ND (US)

(72) Inventor: Jon M. Polries, Sykeston, ND (US)

(21) Appl. No.: 17/894,407

(22) Filed: Aug. 24, 2022

(51) Int. Cl. A01D 90/10; A01D 90/12; B60P 1/40

(52) U.S. Cl. CPC A01D 90/10; A01D 90/12; B60P 1/40; B65G 33/14

(57) ABSTRACT

A field grain cart is expandable for increasing holding capacity and contractible for providing transportability. The field grain cart includes a hopper including a center section, one or more expandable side sections that are movably attached to the center section, a base section that is disposed underneath the hopper, a floor conveyor that is disposed in the hopper, and a spout that is in communication with the hopper.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

The described example embodiments in general relate to a field grain cart with expandable sides for increasing its holding capacity. The field grain cart may have one or more augers and a spout for conveying grain or other material from the field grain cart out of the spout.

### Related Art

Any discussion of the related art throughout the specification should in no way be considered as an admission that such related art is widely known or forms a part of common general knowledge in the field.

Field grain carts are used to receive grain, other crops, or other granular materials from a machine such as a harvester directly in the field such as during harvest. These carts can also be used to transport seed to a planter. More particularly, such carts are typically used to receive, transport and unload various types of field crops such as, but not limited to, grain, corn, or other types of granular material.

Conventional grain carts include a trailer that is pulled by a tractor through the field next to the harvester. These carts may include an open topped harvester that receives various volumes of harvested crop from the harvester in real-time. When the hopper is full, the cart is transported to a location in the field to unload to a truck or other transport device using an unloading conveyor such as an auger in a spout that extends from a side of the hopper. The hopper may include a floor conveyor such as another auger that moves the crop or grain towards the unloading conveyor where the unloading conveyor is angled upwardly to lift the crop or grain upwardly from the hopper into the transport vehicle.

When using such conventional systems, the transport of the cart as well as its capacity may limit the efficiency of the harvesting process. For example, it is desirable that the cart and its hopper be as large as possible to allow as much grain or other granular material be held in the hopper. However, this may negatively impact the transport of the cart from one place in the field to another. Vice versa, a more compact cart may be easily transported but is limited in its holding capacity. Thus, it is desirable to break this compromise between the holding capacity and the transportability of the cart.

### SUMMARY

Some of the various embodiments of the present disclosure relate to a field grain cart that can expand to increase its holding capacity and contract to ease its transport. Some of the various embodiments of the present disclosure include one or more movable side sections of the hopper of the field grain cart that allow the aforementioned contraction and expansion.

In some embodiments, the field grain cart comprises a hopper including a center section, one or more expandable side sections that are movably attached to the center section, a base section that is disposed underneath the hopper, a floor conveyor that is disposed in the hopper, and a spout that is in communication with the hopper.

In alternative embodiments, the base section includes a first support platform that is configured to contact or nearly contact the first expandable side section, and a second support platform that is configured to contact or nearly contact the second side section.

In yet further embodiments, the spout is foldable as well as the first expandable side section and the second expandable side section. The spout may be laterally spaced away from the outer lateral extremities of the first expandable side section and the second expandable section when the side sections and the spout are in their folded configuration.

There has thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different figures use identical reference numbers, the elements are generally either identical or at least similar in function or purpose.

### BRIEF DESCRIPTION OF THE DRAWINGS

FIG. 1 is an environmental view of a field grain cart in accordance with an example embodiment being unloaded.

FIG. 2 is a perspective view of the field grain cart of FIG. 1 shown in isolation. The expandable sides of the field grain cart are shown in an expanded state.

FIG. 3 is a front view of the field grain cart of FIG. 2.

FIG. 4 is a right side view of the field grain cart of FIG. 2.

FIG. 5 is a top view of the field grain cart of FIG. 2.

FIG. 6 is a bottom view of the field grain cart of FIG. 2.

FIG. 7 is a front view of the field grain cart of FIG. 2 with the side walls of the expanded sides removed, leaving the side support structures shown.

FIG. 8 illustrates the field grain cart of FIG. 7 with the side support structures folded up.

FIG. 9 depicts the field grain cart of FIG. 8 with the spout and its associated auger folded up, forming a transport configuration of the field grain cart.

FIG. 10 is a front view of the center section of the hopper of the field grain cart of FIG. 2 shown in isolation.

FIG. 11 is a front view of the center section of FIG. 10 shown along with the side walls of the expandable sides.

FIG. 12 is a front view center section of FIG. 10 shown along with the side support structures in an expanded state.

### DETAILED DESCRIPTION

Some of the various embodiments of the present disclosure relate to a field grain cart that can expand to increase its grain holding capacity and contract to facilitate its transport. Some of the various embodiments of the present disclosure include one or more expandible side sections that increase capacity, but that can also contract to increase the transportability of the cart. In some example embodiments, support platforms may be provided that may provide support for the one or more expandible/contractible side sections. In some other example embodiments, a foldable spout is also provided with the expandible/contractible side sections.

The first expandible side section, as well as the second expandible side section, may be rotatably via a hinge, etc. to a central section of the cart, allowing them to be folded up or down depending on whether it is desirable to provide increased holding capacity or increased transportability.

### A. Overview.

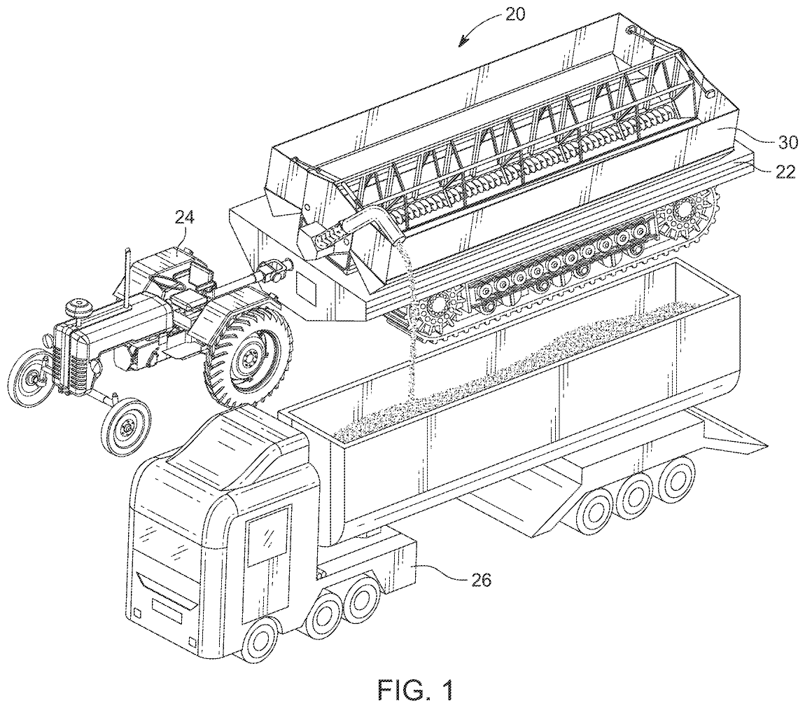

Starting with FIG. 1, an example of a field grain storage and unloading system 20 may be seen. The system includes a trailer with a bed, or a mobile platform 22 that may be hauled by a tractor 24 or a similar machine, a truck 26 or other transportation device for moving the grain or other granular material from the site, and a grain field cart 30 or pod that may store the grain or other granular material, until it is desirable to empty the pod, or at least a portion thereof into the truck 26. The system 20 may include other forms of machines including train cars, harvesting equipment, etc.

### B. Field Grain Cart.

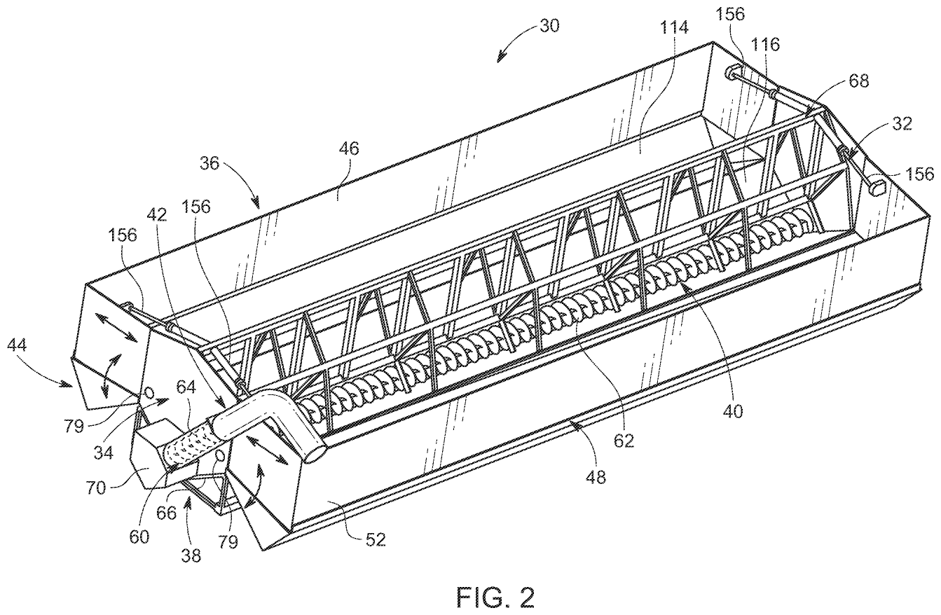

Referring now to FIG. 2, a field grain cart 30 according to an embodiment of the present disclosure may comprise a hopper 32 for receiving the grain or other granular material that includes a center section 34, a first expandable side section 36 that is movably attached to the center section 34, a base section 38 (or central support section) that is disposed underneath the hopper 32, a floor conveyor 40 that is disposed in the hopper 32, and a spout 42 that is in communication with the hopper 32.

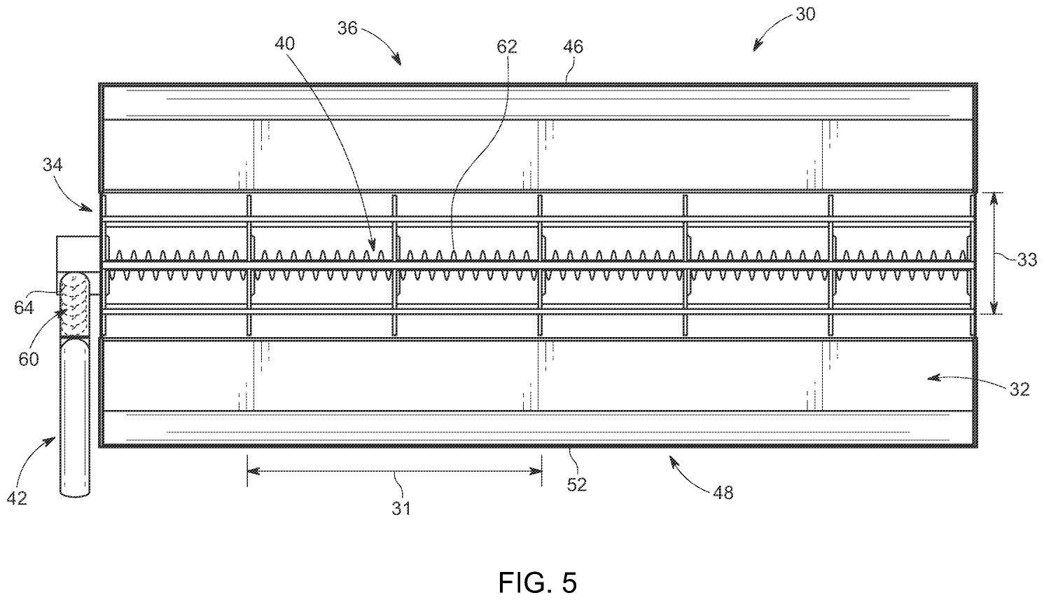

As best seen in FIG. 5, the field grain cart 30 has a generally rectangular shape defining a longitudinal direction 31, and a lateral direction 33. Other shapes are possible such as round in other embodiments of the present disclosure.

Looking at FIGS. 2, 7, and 8, the first expandable side section 36 is shown to be rotatably attached to the center section 34 via a rotating joint, a hinge 79, etc. The first expandable side section 36 may include a first side support structure 44 that is rotatably attached to the center section 34, and a first side wall section 46 that rests on top of the first side support structure 44 (see FIG. 2).

Similarly, a second expandable side section 48 (may be identically configured as the first expandible side section 36) may be provided that is movably attached to the center section 34. The second expandable side section 48 may be supported by a second side support structure 50 that is rotatably or otherwise movably attached (e.g., may be slidably attached) to the center section 34, and a second side wall section 52 that rests on top of the second side support structure 50.

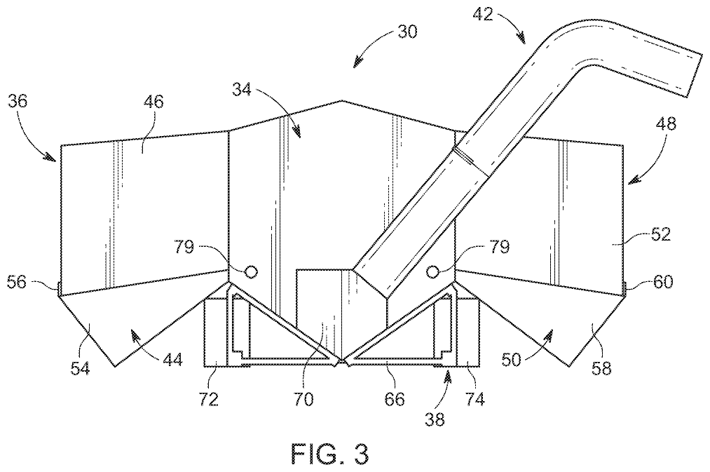

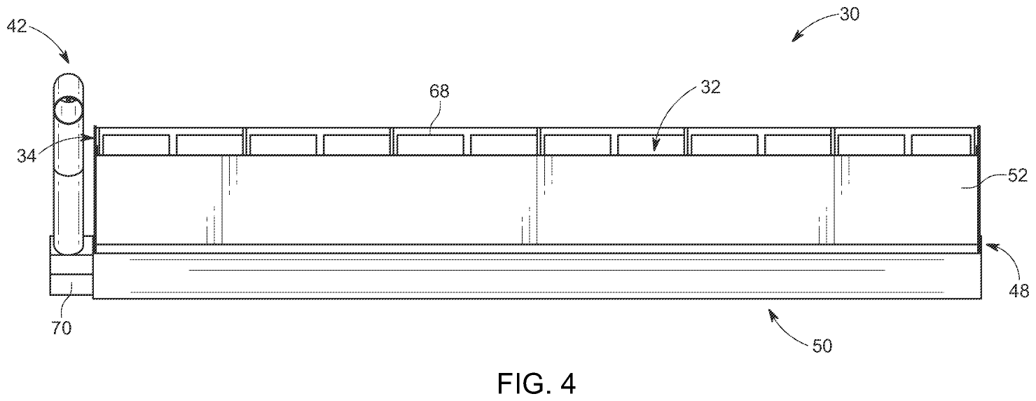

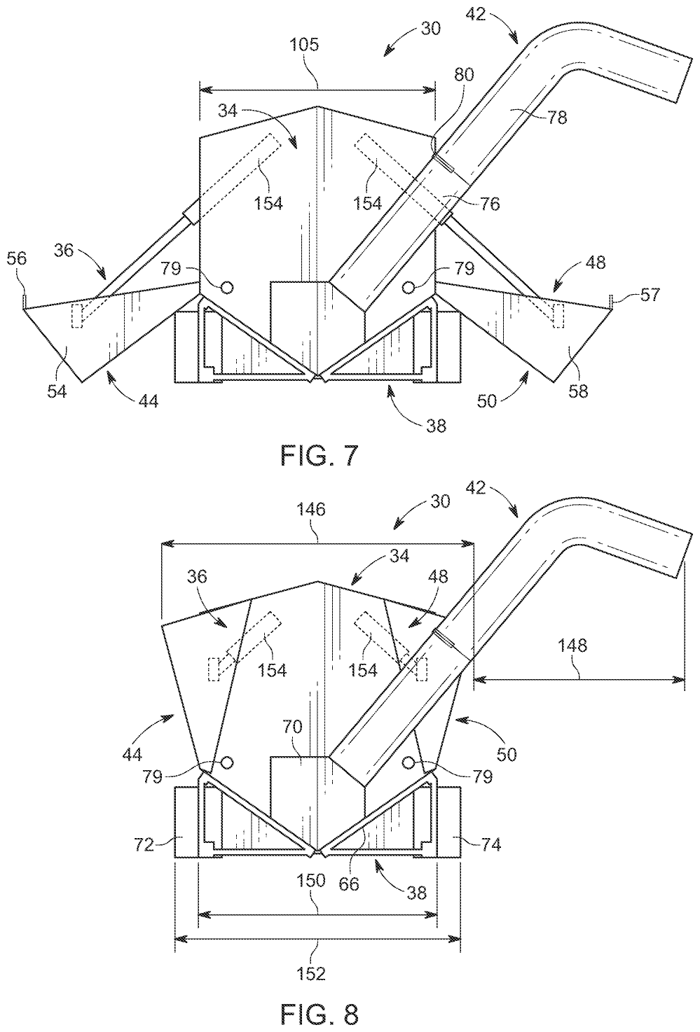

Referring now to FIGS. 3 and 7, the first side support structure 44 may include a first triangularly shaped bottom portion 54, and a first lip 56 that extends vertically upwardly from the first triangularly shaped bottom portion 54. The first lip 56 is shown in FIG. 3 to laterally trap the first side wall section 46 against outer lateral movement. The first side wall section 46 is prevented from moving longitudinally by the center section 34 since the first side wall section is trapped behind the center section 34.

More particularly, the center section 34 may include a first vertical side surface 94 that extends past a portion of the first side wall section 46, and a second side surface 96 that extends laterally past the second side wall section 52 to help prevent longitudinal movement of the first expandable side section 36 and the second expandable side section 48.

Likewise, the second side support structure 50 may include a second triangularly shaped bottom portion 58, and a second lip 57 that extends upwardly from the second triangularly shaped bottom portion 58. The lips and the side support structures may be identically configured, only requiring rotation of 180 degrees to be used as one or the other.

Looking at FIGS. 2 and 5, the cart 30 may further comprise an upwardly extending conveyor 60 that is disposed in the spout 42. In some embodiments of the present disclosure, the floor conveyor 40 includes a horizontally extending auger 62 as shown or other type of conveyor (a belt, etc.). Similarly, the upwardly extending conveyor 60 may include an at least partially vertically extending auger 64 as shown, or another type of conveyor (a belt, etc.). Floor panels 114 of the first side support structure 44 lead to center floor panels 116 of the center section 34. These sloping surfaces act as a funnel at various times during the operation using gravity to feed grain or other granular material to the floor conveyer 40.

In operation, the horizontal auger or conveyor may push material toward the vertical auger or conveyor to push material out of the spout 42 into a truck 26 or train car, etc. In some cases, one or the other conveyor may be omitted.

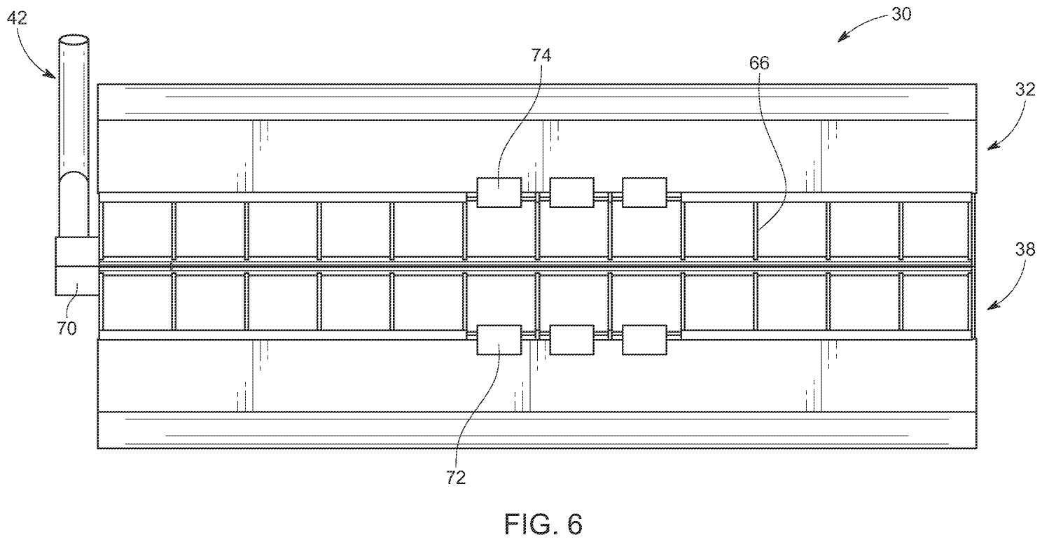

In FIGS. 2, 3, and 6 the base section 38 includes a base truss assembly 66 to help support the load of the hopper 32 when it is filled with material. Moreover, a hopper truss assembly 68 may be disposed above the floor conveyor 40 to provide support for the hopper 32 and prevent heavy objects from damaging the floor conveyor 40, etc. Also, and a motor housing 70 may be disposed adjacent the upwardly extending conveyor 60, and the floor conveyor 40. A motor may be placed in the motor housing 70 that supplies power to move either or both of these conveyors.

In some embodiments of the present disclosure, the cart 30 includes a first expandable side section 36 that is movably attached to the center section 34, as well as a second expandable side section 48 that is movably attached to the center section 34 simultaneously. As best seen in FIG. 3, the first expandable side section sits on or nearly contacts (within 0.5 feet or less) a first support platform 72, while the second expandable side section 48 sits on or nearly contacts (within 0.5 feet or less) a second support platform 74. Put another way, the platforms 72, 74 are configured to support or nearly support the side sections 36, 48. The side sections 36,48 may be supported on the bed of the trailer or mobile platform 22 with slight clearance between them and the support platforms 72, 74. Though not explicitly shown, the platforms 72,74 may have chamfered surfaces that support the corresponding surfaces of the expandable side sections 36, 48.

As shown in FIG. 8, the first expandable side section 36 may be folded up resulting in it being spaced away from the first support platform 72, while the second expandable side section 48 may also be folded such that it is spaced away from the second support platform 74. This may be done after the side walls of these sections have been first removed as indicated by FIG. 7.

Turning now to FIGS. 7 thru 9, the spout 42 may include a first straight portion 76, and a second angled portion 78 that is movably connected to the first straight portion 76 via a hinge 80 or other type of joint.

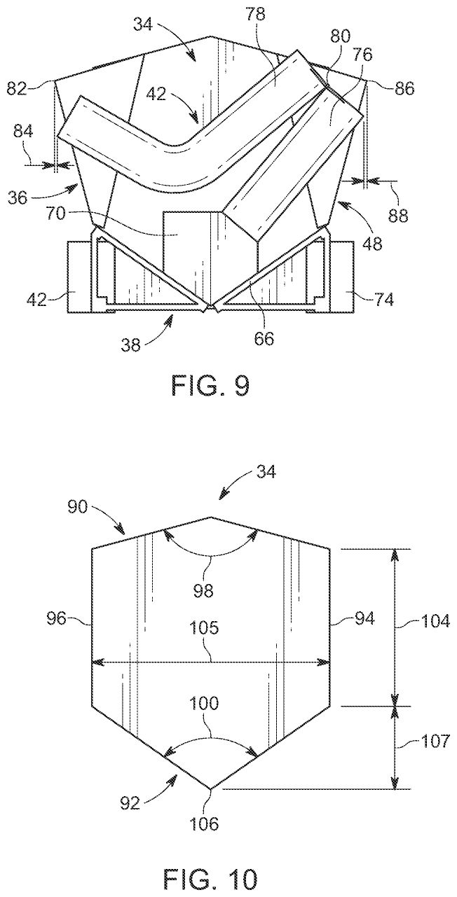

In FIG. 9, the second angled portion 78 may be spaced laterally inwardly away from a first lateral outward extent 82 or extremity of the first expandable side section 36 a first offset distance 84, while at the same time the first straight portion 76 may be spaced laterally inwardly away from a second lateral outward extent 86 or extremity of the second expandable side section 48 a second offset distance 88 (either of these offset distances may be less than a foot). As a result, the spout 42 is somewhat protected from damage by the side sections during transport. This may not be the case in other embodiments of the present disclosure.

### C. Center Section.

Turning now to FIG. 10, the center section 34 will now be described as a standalone assembly in more detail. The center section may include an angled top portion 90, an angled bottom portion 92, a first vertical side surface 94, and a second vertical side surface 96. In general, the center section 34 may be described as having a hexagonal shape or perimeter.

The angled top portion 90 may define a top included angle 98 ranging from 140.0 degrees to 160.0 degrees, while the angled bottom portion 92 forms a bottom included angle 100 ranging from 100.0 degrees to 120.0 degrees. Also, the first vertical side surface 94 defines a vertical distance 104 that ranges from 6.0 feet to 7.0 feet, and the second vertical side surface 96 is spaced away from the first vertical side surface 94 a horizontal width 105 that ranges from 9.5 feet to 10.5 feet. The angled bottom portion 92 defines a vertical distance 107 from the first vertical side surface 94 to an apex of 106 of the angled bottom portion 92 that ranges from 3.0 feet to 4.0 feet.

### D. Side Wall Section.

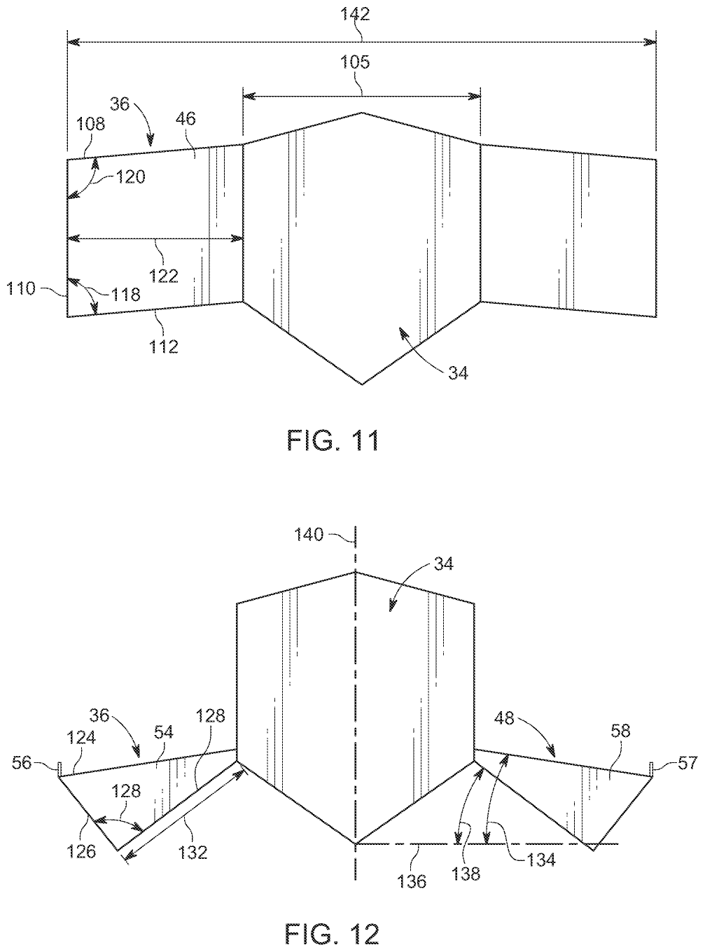

Looking at FIG. 11, the side wall section 46 of the expandable side section 36 will now be discussed in further detail. The side wall section 46 may comprise a top sloping surface 108, a vertical side surface 110, and a bottom sloping surface 112 that is parallel to the top sloping surface 108.

Still referring to FIG. 11, the vertical side surface 110 forms an acute angle with the bottom sloping surface 112 ranging from 80.0 degrees to 90.0 degrees. In addition, the vertical side surface 110 forms an obtuse angle 120 with the top sloping surface 108 ranging from 90.0 degrees to 100.0 degrees, and the side wall section 46 defines a side wall horizontal dimension 122 that ranges from 7.0 feet to 8.0 feet.

### E. Expandable Side Section.

Further details of the expandable side section will now be discussed looking at FIG. 12. The expandable side section 36, 48 includes a triangular shaped bottom portion 54, 58 including an upper surface 124, a first lower surface 126, and a second lower surface 128.

The first lower surface 126 forms an obtuse included angle 130 with the second lower surface 128 that ranges from 90.0 degrees to 95.0 degrees, and the second lower surface 128 extends to the center section 34, defining a length 132 that is greater than 6.0 ft.

The upper surface 124 defines a first angle 134 with a horizontal plane 136 that ranges from 8.0 degrees to 9.0 degrees, and the second lower surface 128 defines a second angle 138 with the horizontal plane 136 that ranges from 35.0 degrees to 40.0 degrees.

The field grain cart 30, including the center section 34 and expandable side section subassembly, may define a vertical plane 140 of symmetry (except for the augers and the spout), and an overall horizontal dimension 142 that ranges from 24.0 feet to 26.0 feet (see FIG. 11).

Various other dimensions will now be discussed referring to FIG. 8. The width 146 from vertex to vertex when the side sections are folded up may range from 13.0 ft to 13.5 feet. The spout may extend laterally a clearance distance 148 of almost 9.0 feet (+/−0.1 foot) from a vertex of the side section. The lateral center to center distance 150 between the support platforms may be about 10.0 feet (+/−0.250 foot), and the outside lateral dimension 152 between the support platforms may be about 12.0 feet (+/−0.250 foot).

It is to be understood that any of the dimensional and angular ranges may be varied to be different than what has been discussed herein. For example, it is contemplated that the embodiments disclosed herein may be scaled up or down depending upon the application.

It is also to be understood that the center section, side section, support section, etc. may be subassemblies made of metal components (e.g., plates) that are connected to each other via welding, fastening, etc. The trusses may be made from angle iron or metal tubing, etc. that are connected via welding, fastening, etc. Walls and floors may be made from sheet metal or other similar materials, etc.

In operation, the first expandable side section 36 and the second expandable side section 48 may be extended to increase the holding capacity of the field grain cart 30, or contracted to ease its transportability. Also, the spout 42 may be folded to ease the transportability of the field grain cart 30.

Specifically, to transform the field grain cart 30 from its transportation configuration to its storage configuration, a pair of hydraulic cylinders 154 (see FIGS. 7 and 8) that are powered via hoses that convey hydraulic fluid supplied by a pump that is disposed inside the motor housing and powered by the motor, will expand, lowering the first side support structure 44, and the second side support structure 50.

Then, another hydraulic cylinder(s) 156 (see FIG. 2) that is also powered by the pump in a similar manner expand causing the first side wall section 46 to slide onto the first side support structure 44, and the second side wall section 56 to slide onto the second side support structure 50. This sliding motion continues until the first side wall section 46 contacts or nearly contacts the first lip 56, and the second side wall section 52 contacts or nearly contacts the second lip 57. Dovetail, mortise and tenon, or V-shaped features may be provided between the upper surface 124 (see FIG. 11) of the first side support structure 44, and the bottom sloping surface 112 (see FIG. 12) of the first side wall section 46 to allow a controlled sliding motion, etc.

Now, this structure or configuration of the grain cart or pod can be loaded by normal grain harvesting equipment. It can hold up to 10,000 bushels of grain (e.g., if the overall longitudinal length is about 60.0 feet, and the overall lateral width is about 25.0 feet) and be unloaded into trucks at any time. The cart or pod may eliminate bottlenecks of labor and/or trucks, giving the operator more flexibility to get the grain transported at a more convenient time.

During the unloading process, the first side wall section 46 and/or the second side wall section 52 may be pulled laterally inwards, forcing grain or other granular material toward the center floor panels 116 that act as a funnel toward the floor conveyor 40 as previously described herein. Once the contraction of the first side wall section 46, and/or the second side wall section 52 is complete, then the first side support structure 44, and/or the second side support structure 50 may be rotated upwards. Eventually as the floor panels 114 (see FIG. 2) rise, they too act like a funnel sending grain or other granular material to the floor conveyor 40. Hence, these movements provide a more effective way to empty the apparatus.

Unless otherwise defined, all technical and scientific terms used herein have the same meaning as commonly understood by one of ordinary skill in the art to which this invention belongs. Although methods and materials similar to or equivalent to those described herein can be used in the practice or testing of the various embodiments of the present disclosure, suitable methods and materials are described above. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls. The various embodiments of the present disclosure may be embodied in other specific forms without departing from the spirit or essential attributes thereof, and it is therefore desired that the various embodiments in the present disclosure be considered in all respects as illustrative and not restrictive. Any headings utilized within the description are for convenience only and have no legal or limiting effect.

What is claimed is:

1. A field grain cart, comprising:
a hopper including
a center section,
a first expandable side section that is movably attached to the center section;
a base section that is disposed underneath the hopper;
a floor conveyor that is disposed in the hopper; and
a spout that is in communication with the hopper.

2. The field grain cart of claim 1, wherein the first expandable side section is rotatably attached to the center section.

3. The field grain cart of claim 2, wherein the first expandable side section includes a first side support structure that is rotatably attached to the center section, and a first side wall section that rests on top of the first side support structure.

4. The field grain cart of claim 3, wherein the hopper further comprises a second expandable side section that is movably attached to the center section.

5. The field grain cart of claim 4, wherein the second expandable side section includes a second side support structure that is rotatably attached to the center section, a second side wall section that rests on top of the second side support structure, the first side wall section is adapted to slide onto the first side support structure, and the second side wall section is adapted to slide onto the second side support structure.

6. The field grain cart of claim 3, wherein the first side support structure includes a first triangularly shaped bottom portion, and a first lip that extends vertically upwardly from the first triangularly shaped bottom portion.

7. The field grain cart of claim 5, wherein the second side support structure includes a second triangularly shaped bottom portion, and a second lip that extends upwardly from the second triangularly shaped bottom portion.

8. The field grain cart of claim 1, further comprising an upwardly extending conveyor that is disposed in the spout.

9. The field grain cart of claim 1, wherein the floor conveyor includes a horizontally extending auger.

10. The field grain cart of claim 8, wherein the upwardly extending conveyor includes an at least partially vertically extending auger.

11. The field grain cart of claim 1, wherein the base section includes a base truss assembly.

12. The field grain cart of claim 8, further comprising a hopper truss assembly that is disposed above the floor conveyor, and a motor housing that is disposed adjacent the upwardly extending conveyor and the floor conveyor.

13. A field grain cart, comprising:
a hopper including
a center section,
a first expandable side section that is movably attached to the center section,
a second expandable side section that is movably attached to the center section;
a base section that is disposed underneath the hopper;
a floor conveyor that is disposed in the hopper; and
a spout that is in communication with the hopper;
wherein the base section includes a first support platform that is configured to contact or nearly contact the first expandable side section, and a second support platform that is configured to contact or nearly contact the second expandable side section.

14. The field grain cart of claim 13, wherein the first expandable side section sits on the first support platform, and the second expandable side section sits on the second support platform.

15. The field grain cart of claim 13, wherein the first expandable side section is folded up being spaced away from the first support platform, and the second expandable side section is folded up being spaced away from the second support platform.

16. The field grain cart of claim 15, wherein the spout includes a first straight portion, and a second angled portion that is hinged to the first straight portion.

17. The field grain cart of claim 16, wherein the second angled portion is spaced laterally inwardly away from a first lateral outward extent of the first expandable side section a first offset distance, and the first straight portion is spaced laterally inwardly away from a second lateral outward extent of the second expandable side section a second offset distance.

18. A field grain cart, comprising:
a hopper including
a center section,
a first expandable side section that is movably attached to the center section,
a second expandable side section that is movably attached to the center section;
a base section that is disposed underneath the hopper;
a floor conveyor that is disposed in the hopper; and
a foldable spout that is in communication with the hopper;
wherein the foldable spout is in a folded configuration, and the first expandable side section is folded up, and the second expandable side section is folded up.

19. The field grain cart of claim 18, wherein the center section includes a first side surface that extends laterally past the first expandable side section, and a second side surface that extends laterally past the second expandable side section.

20. The field grain cart of claim 18, wherein the center section includes a first bottom angled surface that contacts the base section, and a second bottom angled surface that contacts the base section.
